(19) United States
(12) Patent Application Publication
(10) Pub. No.: US 2015/0146046 A1
(43) Pub. Date: May 28, 2015

(54) SOLID-STATE IMAGING DEVICE, DIGITAL CAMERA, AND IMAGE PROCESSING METHOD

(71) Applicant: Kabushiki Kaisha Toshiba, Minato-ku (JP)

(72) Inventors: Takayuki OGASAHARA, Yokohama (JP); Ken Tanabe, Ota (JP); Katsuo Iwata, Yokohama (JP); Kazuhiro Nagata, Yokohama (JP); Ninao Sato, Mitaka (JP)

(73) Assignee: Kabushiki Kaisha Toshiba, Minato-ku (JP)

(21) Appl. No.: 14/461,652

(22) Filed: Aug. 18, 2014

(30) Foreign Application Priority Data
Nov. 25, 2013 (JP) 2013-243259

(51) Int. Cl. H04N 5/357

(52) U.S. Cl. CPC H04N 5/357
USPC 348/241

(57) ABSTRACT

According to one embodiment, a solid-state imaging device includes an image sensor and a resolution reconstruction circuit. The image sensor captures an object image. The resolution reconstruction circuit performs a resolution reconstruction process on the object image. The resolution reconstruction circuit performs a filtering process as the resolution reconstruction process. A filter has a filter property of reducing a modulation transfer function relative to an ideal modulation transfer function in a frequency range of a frequency higher than a frequency set in advance.

### CROSS-REFERENCE TO RELATED APPLICATIONS

This application is based upon and claims the benefit of priority from Japanese Patent Application No. 2013-243259, filed on Nov. 25, 2013; the entire contents of all of which are incorporated herein by reference.

### FIELD

Embodiments described herein relate generally to a solid-state imaging device, a digital camera, and an image processing method.

### BACKGROUND

Conventionally, a Bayer array is generally adopted as the color array of an image sensor provided to a solid-state imaging device. The Bayer array takes a 2×2 pixel block as the unit. A red (R) pixel and a blue (B) pixel are arranged on the opposing corners of the pixel block, and two green (G) pixels are arranged on the remaining opposing corners. Of the two G pixels included in the pixel block, the G pixel that is adjacent to the R pixel in the row direction is referred to as a Gr pixel. Of the two G pixels included in the pixel block, the G pixel that is adjacent to the B pixel in the row direction is referred to as a Gb pixel.

As the cause for reduction in the color reproducibility by an image sensor, there is optical or electrical crosstalk (color mixture) between adjacent pixels, for example. To cope with miniaturization of a camera module, and an increase in the number of pixels, pixels of the image sensor are becoming miniaturized. The image sensor is more susceptible to the influence of crosstalk as the pixels are made smaller.

With the image sensor, a difference in the light sensitivity may occur between adjacent pixels due to reflection light from a wiring layer of a photodiode. When the amount of reflected light from the wiring layer is not uniform due to the symmetry of the structure of the photodiode or the like, a difference in sensitivity may occur between adjacent pixels. With a photodiode provided with a back wiring, the influence of reflected light from the back wiring is greater as the silicon layer on the back wiring is thinner.

When a difference in the sensitivity occurs between the Gr pixel and the Gb pixel due to these causes, illuminance unevenness not present in an object may appear in an image as a lattice pattern, for example. To reduce the illuminance unevenness that is caused by a difference in the sensitivity of the Gr pixel and the Gb pixel, an image sensor that performs an averaging process on the signal that is output from the Gr pixel and the signal that is output from the Gb pixel is conventionally known. However, the level of perceived resolution of an image of the image sensor is greatly reduced by such an averaging process.

In the case of improving the structures of photodiodes, the structures have to be determined by taking into account the balance between the performances of the photodiodes. It is extremely difficult to develop structures of photodiodes that are capable of reducing the difference in the sensitivity between the pixels.

### BRIEF DESCRIPTION OF THE DRAWINGS

FIG. 1 is a block diagram illustrating a schematic configuration of a solid-state imaging device according to a first embodiment;

FIG. 2 is a block diagram illustrating a schematic configuration of a digital camera provided with the solid-state imaging device;

FIG. 3 is a diagram illustrating a schematic configuration of an optical system provided to the digital camera;

FIG. 4 is a block diagram illustrating a configuration of a signal processing circuit;

FIG. 5 is a diagram for describing a relationship between an MTF and a spatial frequency;

FIG. 6 is a diagram schematically illustrating an example of an image that is obtained by transforming an image in a real space into a frequency space; and

FIG. 7 is a diagram schematically illustrating a state where a low-pass filter based on a reconstruction filter is applied to the image illustrated in FIG. 6.

### DETAILED DESCRIPTION

In general, according to one embodiment, a solid-state imaging device includes an image sensor and a resolution reconstruction circuit. The image sensor captures an object image. The resolution reconstruction circuit performs a resolution reconstruction process on the object image. The resolution reconstruction circuit performs a filtering process as the resolution reconstruction process. The filtering process is based on a filter. The filter has a filter property of reducing a modulation transfer function relative to an ideal modulation transfer function in a frequency range of a frequency higher than a frequency set in advance.

Exemplary embodiments of a solid-state imaging device, a digital camera, and an image processing method will be explained below in detail with reference to the accompanying drawings. The present invention is not limited to the following embodiments.

### First Embodiment

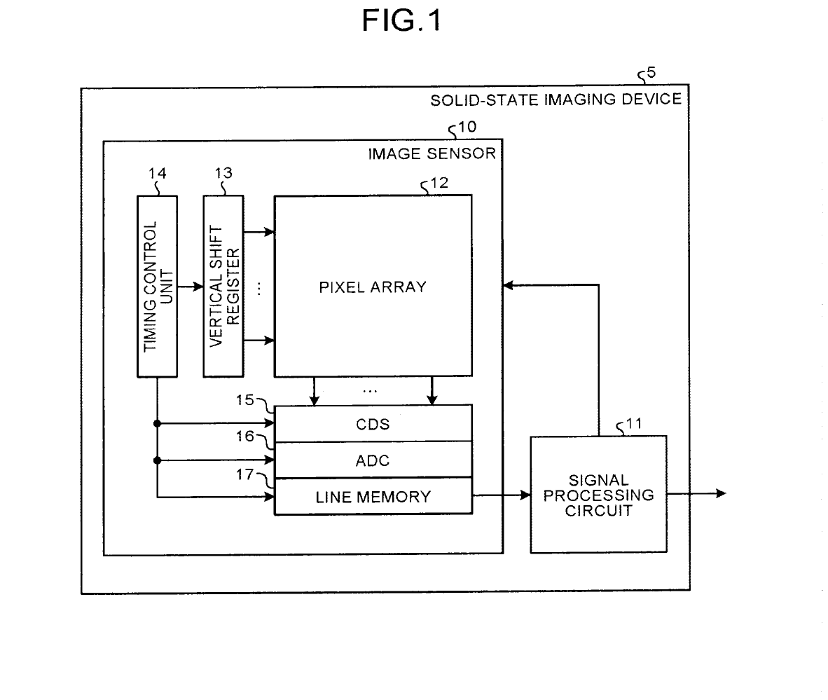

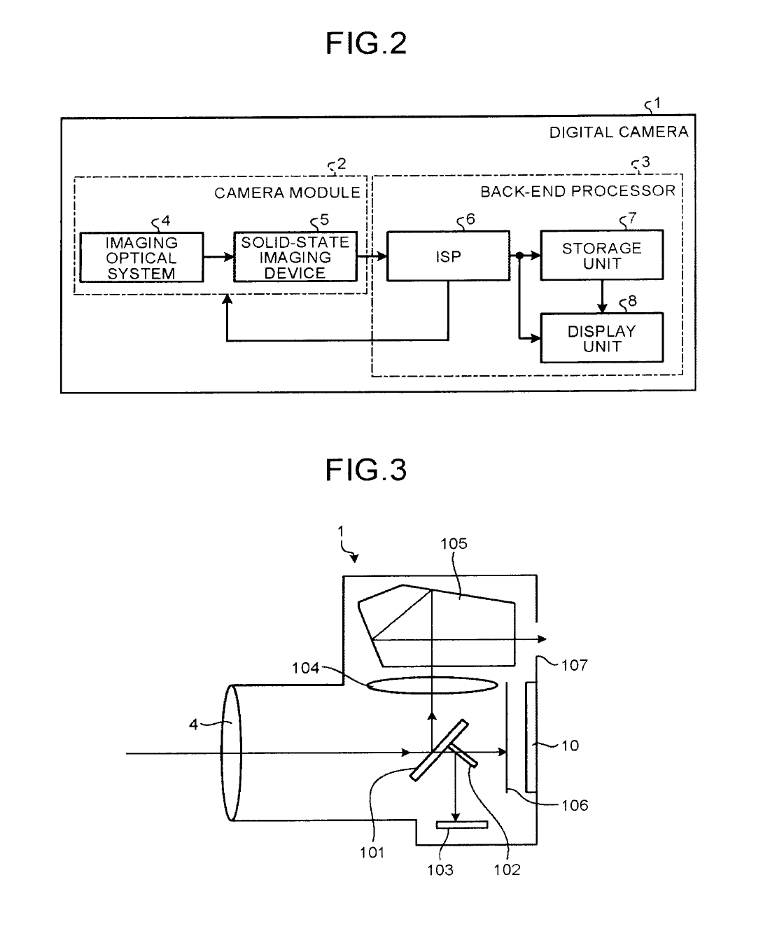

FIG. 1 is a block diagram illustrating a schematic configuration of a solid-state imaging device according to a first embodiment. FIG. 2 is a block diagram illustrating a schematic configuration of a digital camera provided with the solid-state imaging device.

A digital camera 1 includes a camera module 2 and a back-end processor 3. The camera module 2 includes an imaging optical system 4 and a solid-state imaging device 5. The back-end processor 3 includes in image signal processor (ISP) 6, a storage unit 7, and a display unit 8. Other than the digital camera 1, the camera module 2 is applied to an electronic appliance such as a mobile terminal with a camera, for example.

The imaging optical system 4 catches light from an object, and forms an object image. The solid-state imaging device 5 captures the object image. The ISP 6 performs signal processing on an image signal obtained by capturing by the solid-state imaging device 5. The storage unit 7 stores an image on which signal processing has been performed by the ISP 6. The storage unit 7 outputs an image signal to the display unit 8 in response to an operation by a user or the like.

The display unit 8 displays an image according to an image signal input from the ISP 6 or the storage unit 7. The display unit 8 is a liquid crystal display, for example. The digital camera 1 performs feedback control of the camera module 2 based on data on which signal processing has been performed by the ISP 6.

The solid-state imaging device 5 includes an image sensor 10, which is an imaging element, and a signal processing circuit 11, which is an image processing device. The image sensor 10 is a CMOS image sensor, for example. The image sensor 10 may be a CCD, instead of being a CMOS image sensor.

The image sensor 10 includes a pixel array 12, a vertical shift register 13, a timing control unit 14, a correlated double sampling unit (CDS) 15, an analog-to-digital converter (ADC) 16, and a line memory 17.

The pixel array 12 is provided in an imaging region of the image sensor 10. The pixel array 12 is formed of a plurality of pixels arranged in a horizontal direction (a row direction) and a vertical direction (a column direction). Each pixel includes a photodiode, which is a photoelectric conversion element. The pixel array 12 generates signal charge according to the amount of incident light of each pixel.

The timing control unit 14 supplies, to the vertical shift register 13, a vertical synchronization signal which is an instruction regarding timing of reading of a signal from each pixel of the pixel array 12. The timing control unit 14 supplies, to each of the CDS 15, the ADC 16, and the line memory 17, a timing signal which is an instruction regarding driving timing.

The vertical shift register 13 selects a pixel in the pixel array 12 for each row according to the vertical synchronization signal from the timing control unit 14. The vertical shift register 13 outputs a read signal to each pixel in the selected row. A pixel to which a read signal is input by the vertical shift register 13 outputs signal charge accumulated according to the amount of incident light. The pixel array 12 outputs the signal from the pixel to the CDS 15 via a vertical signal line.

The CDS 15 performs a correlated double sampling process for reduction of fixed pattern noise, on the signal from the pixel array 12. The ADC 16 converts an analog signal to a digital signal. The line memory 17 accumulates signals from the ADC 16. The image sensor 10 outputs the signals accumulated in the line memory 17.

The signal processing circuit 11 performs various types of signal processing on an image signal from the image sensor 10. The signal processing circuit 11 performs signal processing such as defect correction, gamma correction, a noise reduction process, lens shading correction, white balance adjustment, distortion correction, resolution reconstruction, and the like. The solid-state imaging device 5 outputs an image signal on which signal processing has been performed by the signal processing circuit 11 to outside the chip. The solid-state imaging device 5 performs feedback control on the image sensor 10 based on data on which signal processing has been performed by the signal processing circuit 11.

FIG. 3 is a diagram illustrating a schematic configuration of an optical system provided to the digital camera. Light entering the imaging optical system 4 of the digital camera 1 from an object proceeds to the image sensor 10 via a main mirror 101, a sub-mirror 102, and a mechanical shutter 106. The digital camera 1 captures an object image at the image sensor 10.

Light reflected by the sub-mirror 102 proceeds to an autofocus (AF) sensor 103. The digital camera 1 performs focus adjustment that uses a detection result of the AF sensor 103. Light reflected by the main mirror 101 proceeds to a finder 107 via a lens 104 and a prism 105.

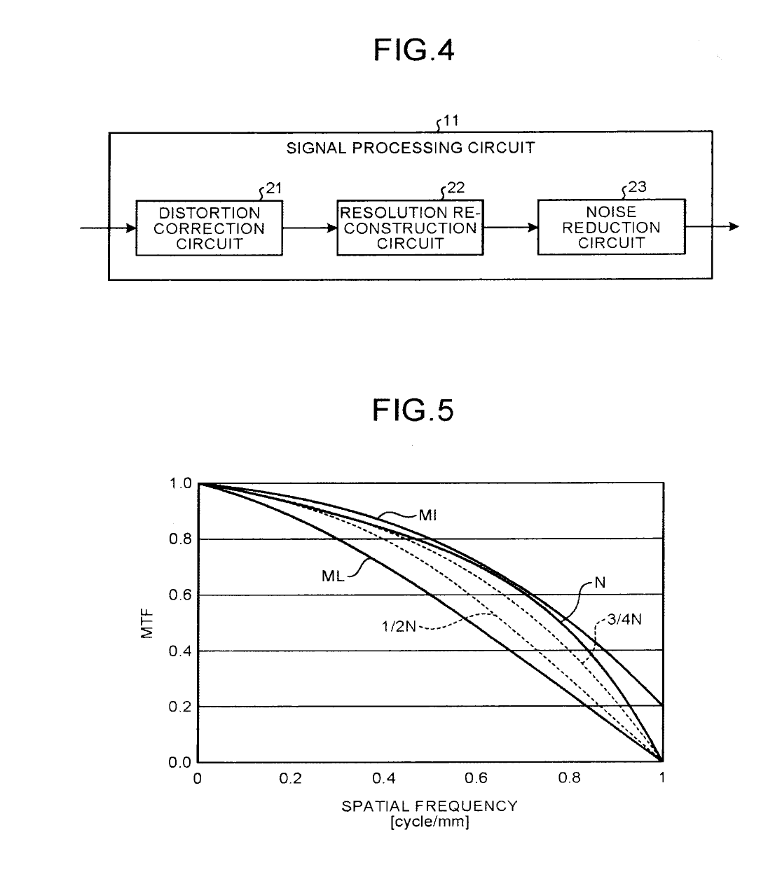

FIG. 4 is a block diagram illustrating a configuration of the signal processing circuit. Among the structures for various types of signal processing at the signal processing circuit 11, structures for each of distortion correction, resolution reconstruction, and noise reduction are illustrated in FIG. 4. Structures for other types of signal processing at the signal processing circuit 11 are omitted from the drawing.

An image signal input to the signal processing circuit 11 is sequentially input to a distortion correction circuit 21, a resolution reconstruction circuit 22, and a noise reduction circuit 23, for example. The distortion correction circuit 21 performs distortion correction on an object image. The distortion correction circuit 21 performs coordinate transformation for returning distortion of a coordinate axis occurring due to a lens provided to the imaging optical system 4 to a square lattice.

The resolution reconstruction circuit 22 performs a resolution reconstruction process on the object image.

The resolution reconstruction circuit 22 performs the resolution reconstruction on the object image based on the lens properties of the lens of the imaging optical system 4, such as chromatic aberration of magnification, axial chromatic aberration, the amount of blur, and the like. As the lens property, a point spread function (PSF) is used, for example. The PSF is estimated by a method such as a least squares method, for example.

The noise reduction circuit 23 performs a noise reduction process on the object image. The noise reduction circuit 23 removes, from the object image, noise such as fixed pattern noise, dark current noise, or shot noise. Additionally, the order of input of an image signal to the distortion correction circuit 21, the resolution reconstruction circuit 22, and the noise reduction circuit 23 may be arbitrarily changed.

According to the digital camera 1, at least one of the various types of signal processing that are to be performed, in the present embodiment, by the signal processing circuit 11 may be performed by the ISP 6 of the back-end processor 3. The digital camera 1 may have at least one of the various types of signal processing performed by both the signal processing circuit 11 and the ISP 6. The signal processing circuit 11 and the ISP 6 may also additionally perform signal processing other than the signal processing described in the present embodiment. The signal processing circuit 11 and the ISP 6 may omit processes that may be omitted, among the signal processing described in the present embodiment.

The resolution reconstruction circuit 22 performs as the resolution reconstruction process, a filtering process that uses a deconvolution filter on image data of the object image in the real space. The deconvolution filter is a deconvolution matrix of the PSF with the property of a low-pass filter described later, for example. As the filtering process, the resolution reconstruction circuit 22 calculates a convolution integral of the deconvolution filter and the image data. The resolution reconstruction circuit 22 mainly emphasizes the radio frequency component of the image data by such a filtering process to thereby reconstruct an image with a reduced blur.

The deconvolution filter is stored in advance in an OTP (One Time Programmable memory; not shown) provided to the solid-state imaging device 5, for example. The OTP stores parameters for signal processing for image signals.

The deconvolution filter is a 5×5 matrix, for example. As the deconvolution filter, a different matrix is prepared for each of R, G, and B. Also, the matrix may be arbitrarily changed according to the image height.

The deconvolution filter has, as the property of a low-pass filter, a filter property of reducing a modulation transfer function (MTF) in a frequency range higher than a frequency set in advance. The MTF is a function indicating modulation of an image of a sinusoidal object relative to an increase in the spatial frequency.

The deconvolution filter includes both the function of resolution reconstruction and the function as a low-pass filter by having each filter value of the deconvolution matrix of the PSF being appropriately adjusted.

FIG. 5 is a diagram for describing a relationship between an MTF and a spatial frequency. The vertical axis of the graph illustrated in FIG. 5 is the MTF, and the horizontal axis is the spatial frequency (cycle/mm). The solid line denoted by “MI” is an ideal MTF of the lens. The ideal MTF expresses a relationship between the spatial frequency and the MTF of a stigmatic lens as an ideal lens. The solid line denoted by “ML” is an example of a relationship between the spatial frequency and the MTF of a low-resolution lens. The MTF of a low-resolution lens takes a value that is significantly lower than the ideal MTF in any frequency range.

The solid line denoted by “N” is an example of a relationship between the MTF and the spatial frequency where a filtering process of reducing the MTF near a Nyquist frequency has been performed. The MTF in this case is lower than the ideal MTF in a frequency range near the Nyquist frequency, but takes a value that is close to the ideal MTF in a frequency range lower than near the Nyquist frequency.

The dotted line denoted by “¾ N” is an example of a relationship between the MTF and the spatial frequency where a filtering process of reducing the MTF in a frequency range higher than a frequency (¾ Nyquist) corresponding to three-quarters of the Nyquist frequency has been performed. The MTF in this case is lower than the ideal MTF in a frequency range near or higher than the ¾ Nyquist, but takes a value that is close to the ideal MTF in a frequency range lower than near the ¾ Nyquist.

The dotted line denoted by “½ N” is an example of a relationship between the MTF and the spatial frequency where a filtering process of reducing the MTF in a frequency range higher than a frequency (½ Nyquist) half the Nyquist frequency has been performed. The MTF in this case is lower than the ideal MTF in a frequency range near or higher than the ½ Nyquist, but takes a value that is close to the ideal MTF in a frequency range lower than near the ½ Nyquist.

The visual sense of human being is said to be relatively sensitive to the resolution in a frequency range near the ½ Nyquist. Accordingly, in a frequency range near the ½ Nyquist, if the MTF is slightly reduced relative to the ideal MTF, deterioration of the resolution is easily sensed by a human being. On the other hand, in a frequency range higher than near the ¾ Nyquist, deterioration of the level of perceived resolution is not greatly sensed by a human being even if the MTF is reduced relative to the ideal MTF.

The deconvolution filter used by the resolution reconstruction circuit 22 has a filter property of reducing the MTF relative to the ideal MTF in a frequency range higher than the ¾ Nyquist which is a frequency set in advance.

According to the first embodiment, by providing the property of a low-pass filter to the deconvolution filter, the solid-state imaging device 5 may effectively reduce the lattice-patterned illuminance unevenness that is caused due to a difference in the sensitivity between the Gr pixel and the Gb pixel. With the filter property of the deconvolution filter being adjusted to cut a frequency range higher than the ¾ Nyquist, the solid-state imaging device 5 may suppress deterioration of the level of perceived resolution as much as possible. Compared to a case of performing an averaging process for a signal output from the Gr pixel and a signal output from the Gb pixel, the solid-state imaging device 5 may obtain an image with a high level of perceived resolution.

As described above, the solid-state imaging device 5 and the camera module 2 achieve an effect that a high-quality image with a high level of perceived resolution and not much illuminance unevenness may be captured.

The deconvolution filter is not restricted to one that has a filter property of reducing the MTF relative to the ideal MTF in a frequency range higher than the ¾ Nyquist. The deconvolution filter may be provided with a filter property of reducing the MTF in any frequency range as long as the illuminance unevenness that is caused due to a difference in the sensitivity between the Gr pixel and the Gb pixel may be effectively reduced, and the deterioration of the level of perceived resolution may be suppressed to a desired level.

### Second Embodiment

A solid-state imaging device according to a second embodiment has the same configuration as the solid-state imaging device according to the first embodiment illustrated in FIG. 1. Parts of the solid-state imaging device according to the second embodiment which are the same as those of the first embodiment are denoted by the same reference numerals, and redundant description is omitted as appropriate.

The resolution reconstruction circuit 22 (see FIG. 4) performs Fourier transform of an object image from a real space to a frequency space, and inverse Fourier transform of the object image from the frequency space to the real space. The Fourier transform is fast Fourier transform (FFT), for example. The inverse Fourier transform is inverse transform (IFFT) of the fast Fourier transform.

The resolution reconstruction circuit 22 performs a filtering process on image data which has been transformed by Fourier transform from the real space to the frequency space. As a resolution reconstruction process, the resolution reconstruction circuit 22 performs a filtering process that uses a reconstruction filter in the frequency space on the image data of the object image in the frequency space. As the reconstruction filter in the frequency space, an inverse filter or a Wiener filter is used, for example. These reconstruction filters in the frequency space are obtained based on an optical transfer function (OTF) that is obtained by performing Fourier transform on the PSF. Moreover, in the present embodiment, the reconstruction filters in the frequency space are provided with the property of a low-pass filter.

As the filtering process, the resolution reconstruction circuit 22 multiplies image data by the reconstruction filter. The resolution reconstruction circuit 22 reconstructs an image with a reduced blur by mainly emphasizing the radio frequency component of the image data by such a filtering process. The reconstruction filter is stored in advance in an OTP provided to the solid-state imaging device 5, for example.

The reconstruction filter has, as the property of a low-pass filter, a filter property of reducing the MTF in a frequency range higher than a frequency set in advance. The reconstruction filter includes both the function of the resolution reconstruction and the function as a low-pass filter by having a filter value obtained based on the OTF appropriately adjusted.

The reconstruction filter to be used by the resolution reconstruction circuit 22 has a filter property of reducing the MTF relative to the ideal MTF in a frequency range higher than the ¾ Nyquist which is a frequency set in advance.

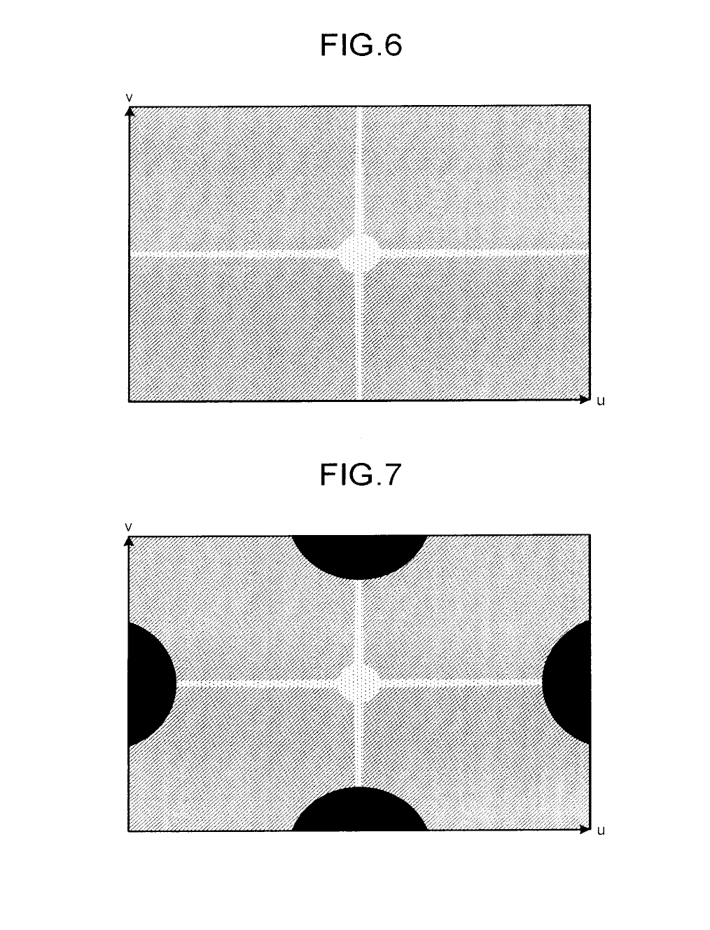

FIG. 6 is a diagram schematically illustrating an example of an image that is obtained by transforming an image in the real space into the frequency space. A two-dimensional image captured by the solid-state imaging device 5 has luminance components spread over a real space on an xy plane, for example. This two-dimensional image is subjected to Fourier transform, and is expressed as an image which is spatial frequency components spread over a frequency space of a u-axis and a v-axis.

FIG. 7 is a diagram schematically illustrating a state where a low-pass filter based on the reconstruction filter is applied to the image illustrated in FIG. 6. By a frequency range higher than ¾ Nyquist which is a frequency set in advance being cut by the reconstruction filter, the image reaches a state where parts corresponding to the frequency range are made black.

According to the second embodiment, by providing the reconstruction filter with the property of a low-pass filter, the solid-state imaging device 5 may effectively reduce lattice-patterned illuminance unevenness that is caused due to a difference in the sensitivity between the Gr pixel and the Gb pixel. With the filter property of the reconstruction filter being adjusted to cut a frequency range higher than the ¾ Nyquist, the solid-state imaging device 5 may suppress deterioration of the level of perceived resolution as much as possible. Compared to a case of performing an averaging process for a signal output from the Gr pixel and a signal output from the Gb pixel, the solid-state imaging device 5 may obtain an image with a high level of perceived resolution.

As described above, also in the second embodiment, the solid-state imaging device 5 and the camera module 2 achieve an effect that a high-quality image with a high level of perceived resolution and not much illuminance unevenness may be captured.

The reconstruction filter is not restricted to one that has the filter property of reducing the MTF relative to the ideal MTF in a frequency range higher than the ¾ Nyquist. The reconstruction filter may be provided with a filter property of reducing the MTF in any frequency range as long as the illuminance unevenness that is caused due to a difference in the sensitivity between the Gr pixel and the Gb pixel may be effectively reduced, and the deterioration of the level of perceived resolution may be suppressed to a desired level.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A solid-state imaging device comprising:
an image sensor that captures an object image; and
a resolution reconstruction circuit that performs a resolution reconstruction process on the object image,
wherein the resolution reconstruction circuit performs a filtering process based on a filter as the resolution reconstruction process, and
wherein the filter has a filter property of reducing a modulation transfer function relative to an ideal modulation transfer function in a frequency range of a frequency higher than a frequency set in advance.

2. The solid-state imaging device according to claim 1, wherein the filter has the filter property of cutting a frequency range component of a frequency higher than a frequency corresponding to three-quarters of a Nyquist frequency.

3. The solid-state imaging device according to claim 1,
wherein the resolution reconstruction circuit performs the filtering process on image data of the object image in a real space, and
wherein the filter is a deconvolution filter.

4. The solid-state imaging device according to claim 3, wherein the deconvolution filter has the filter property of cutting a frequency range component of a frequency higher than a frequency corresponding to three-quarters of a Nyquist frequency.

5. The solid-state imaging device according to claim 3, wherein the deconvolution filter has each filter value of a deconvolution matrix of a point spread function adjusted according to the filter property.

6. The solid-state imaging device according to claim 1,
wherein the resolution reconstruction circuit performs the filtering process on image data of the object image in a frequency space, and
wherein the filter is a reconstruction filter in the frequency space.

7. The solid-state imaging device according to claim 6, wherein the reconstruction filter has the filter property of cutting a frequency range component of a frequency higher than a frequency corresponding to three-quarters of a Nyquist frequency.

8. The solid-state imaging device according to claim 6, wherein the reconstruction filter has each filter value that is obtained based on an optical transfer function adjusted according to the filter property.

9. A digital camera comprising;
an imaging optical system that catches light from an object, and forms an object image; and
a solid-state imaging device that transforms light caught by the imaging optical system into signal charge, and captures the object image,
wherein the solid-state imaging device includes
an image sensor that captures the object image, and
a resolution reconstruction circuit that performs a resolution reconstruction process on the object image,
wherein the resolution reconstruction circuit performs a filtering process based on a filter as the resolution reconstruction process, and
wherein the filter has a filter property of reducing a modulation transfer function relative to an ideal modulation transfer function in a frequency range of a frequency higher than a frequency set in advance.

10. The digital camera according to claim 9, wherein the filter has the filter property of cutting a frequency range component of a frequency higher than a frequency corresponding to three-quarters of a Nyquist frequency.

11. The digital camera according to claim 9,
wherein the resolution reconstruction circuit performs the filtering process on image data of the object image in a real space, and
wherein the filter is a deconvolution filter.

12. The digital camera according to claim 11, wherein the deconvolution filter has the filter property of cutting a frequency range component of a frequency higher than a frequency corresponding to three-quarters of a Nyquist frequency.

13. The digital camera according to claim 11,
wherein the resolution reconstruction circuit performs the resolution reconstruction process based on a point spread function that is a property of the imaging optical system, and
wherein the deconvolution filter has each filter value of a deconvolution matrix of the point spread function adjusted according to the filter property.

14. The digital camera according to claim 9,
wherein the resolution reconstruction circuit performs the filtering process on image data of the object image in a frequency space, and
wherein the filter is a reconstruction filter in the frequency space.

15. The digital camera according to claim 14, wherein the reconstruction filter has the filter property of cutting a frequency range component of a frequency higher than a frequency corresponding to three-quarters of a Nyquist frequency.

16. The digital camera according to claim 14, wherein the resolution reconstruction circuit performs
the resolution reconstruction process based on an optical transfer function that is obtained by performing Fourier transform on a point spread function that is a property of the imaging optical system, and
wherein the reconstruction filter has each filter value that is obtained based on the optical transfer function adjusted according to the filter property.

17. An image processing method comprising:
performing a filtering process for resolution reconstruction on a captured object image; and
reducing, in the filtering process, a modulation transfer function relative to an ideal modulation transfer function in a frequency range of a frequency higher than a frequency set in advance.

18. The image processing method according to claim 17, wherein the frequency set in advance is a frequency corresponding to three-quarters of a Nyquist frequency.
